(19) United States
(12) Patent Application Publication
(10) Pub. No.: US 2002/0154191 A1
(43) Pub. Date: Oct. 24, 2002

(54) Ink jet recording head and fabrication method thereof

(75) Inventors: Torahiko Kanda, Tokyo (JP); Kenichi Ohno, Tokyo (JP); Toru Nishida, Tokyo (JP)

Correspondence Address: Scully, Scott, Murphy & Presser, 400 Garden City Plaza, Garden City, NY, 11530, US

(73) Assignee: Fuji Xerox Co., Ltd.

(21) Appl. No.: 10/124,868

(22) Filed: Apr. 18, 2002

(30) Foreign Application Priority Data
Apr. 24, 2001 (JP) 2001-126279

(51) Int. Cl. B41J 2/135

(52) U.S. Cl. 347/47; 347/44

(57) ABSTRACT

In an ink jet recording head having a crystalline substrate in which at least one nozzle and at least one ink chamber formed in the crystalline substrate, a gap is provided in a connecting portion between the nozzle and the ink chamber below an opening portion of the nozzle such that a variation of the ink jetting function due to an axial deviation between the nozzle and the ink chamber is restricted by absorbing the axial deviation by the gap. The gap is formed such that extension lines of wall surfaces of the ink chamber formed by etching are positioned inside the gap.

### BACKGROUND OF THE INVENTION

1. Field of the Invention

The present invention relates to an ink jet recording head for recording an image or the like by jetting ink droplets to a recording medium and a fabrication method thereof.

2. Description of the Related Art

An ink jet recording head and a fabrication method thereof are proposed in US-2001-0033313-A1 assigned to the assignee of the present application, in which the ink jet recording head includes at least one nozzle for jetting ink droplets, at least one ink chamber in communication with the nozzle for pressurizing ink filling it, at least one branch ink pool for supplying ink to the ink chamber, a main ink pool connected to the branch ink pool for supplying ink from an ink tank thereto and an ink supply port to be connected to the ink tank, all of which are formed in a silicon substrate. In the ink jet recording head proposed, the nozzle is formed vertically in one of crystal faces {100} of the silicon substrate and the ink chamber and the ink pool are formed by anisotropic etching of the silicon substrate such that crystal face {100} appears in surfaces of a partition wall between the ink chamber and the ink pool.

The proposed fabrication method will be described with reference to FIG. 4a to FIG. 4g, which shows fabrication steps for forming the nozzles, the ink chamber and the ink pool in one and the same silicon substrate.

Firstly, a high density boron diffusion layer 2 is formed in crystal face {100} of the silicon wafer 1 shown in FIG. 4a as a layer in which the nozzle is formed (FIG. 4b). And then, as shown in FIG. 4c, a silicon oxide layer 3, which becomes an anti etching mask, is formed on a surface of the silicon wafer 1 by thermal oxidation. Thereafter, the silicon oxide layer 3 is painted with resist material and a resist mask pattern of the nozzle is formed on the wafer surface by photolithography. Thereafter, the silicon oxide layer 3 is etched and the nozzle is opened in a direction perpendicular to the high density boron diffusion layer by dry etching with using the silicon oxide layer 3 as a mask (FIG. 4d).

In order to provide opening portions in positions in which the ink chamber and the branch ink pool are to be formed, a resist pattern is formed. After the silicon oxide layer 3 is etched, the resist is peeled off and the high density boron diffusion layer is etched by using the silicon oxide layer 3 as a mask (FIG. 4e). And then, the ink chamber 11 and the branch ink pool 12 are formed in crystal face {111} by anisotropic etching of silicon as shown in FIG. 4f. Thereafter, as shown in FIG. 4g, a cover plate of the branch ink pool 12 is formed and the ink supply path 13 is formed between the ink chamber 11 and the branch ink pool 12. Further, a pressure generation mechanism 14 such as piezo electric element is provided by bonding or forming a cover plate on the bottom of the ink chamber.

On the other hand, JP H9-57981 A discloses a technique for forming at least one nozzle in a silicon substrate, in which a space is formed in the silicon substrate by anisotropic or isotropic etching from one surface of the silicon substrate and a nozzle jetting port is formed by plasma etching from the other surface, so that the nozzle jetting port is connected to the space.

When an ink jet recording head is fabricated by etching a silicon substrate with using semiconductor fabrication steps, it is possible to make the ink jet recording head compact and to perform highly precise machining. Therefore, it becomes possible to fabricate a highly precise ink jet recording head.

However, when a nozzle and ink chamber is formed in a silicon substrate by using photo etching technology, a positional deviation may occur between the nozzle and the ink chamber. In US-2001-0033313-A1, the nozzle is formed in the vertical direction of the silicon substrate by dry etching from one surface of the silicon substrate and the ink chamber is formed by anisotropic etching from the other surface of the silicon substrate so that it is connected to the nozzle. In this case, there may be a deviation between the axes of the ink chamber and the nozzle due to mask matching error in the photo etching, variation of thickness of the substrate and deviation of crystal faces of the silicon substrate.

FIG. 5a and FIG. 5b show an example of a deviation in the connecting portions of the ink chamber and the nozzle, in which FIG. 5a is a cross section of the connecting portions of the nozzle and the ink chamber and FIG. 5b is a plan view when the nozzle is looked from a bottom of the ink chamber. Since the ink chamber is formed in the silicon surface by anisotropically etching from one surface of the silicon substrate, the ink chamber takes in the form of a pyramid shaped cavity having wall surfaces, which are crystal faces {111}, and the nozzle in opened in an apex of the pyramid.

On the other hand, the ink chamber is formed by anisotropic etching from the other surface of the silicon substrate and is connected to the nozzle. In this case, when the center axis of the nozzle opening deviates from the center axis of the ink chamber as shown in FIG. 5a, jetting characteristics and flying characteristics of ink such as jetting direction and flying direction of ink may be varied, resulting in a problem of printing quality.

In the steps shown in FIG. 4a to FIG. 4g, since the nozzle and the opening portion for etching the ink chamber are formed on the opposite surfaces of the silicon substrate, the photo mask patterns thereof are formed on the respective surfaces and, therefore, the etching must be performed to open the nozzle in a center of the apex of the pyramid. However, since the opening positions of the nozzle and the ink chamber are set by the photo masks, there may be a deviation between aligning positions of these masks. Therefore, in order to machine such that a portion formed on one surface is connected to another portion etched from the other surface, the axis of the nozzle may be deviated from the axis of the ink chamber due to positional deviation between the masks. Further, the axis of the nozzle may be also deviated from the axis of the ink chamber due to slight inclination of the silicon substrate and deviation of the crystal faces of the silicon substrate.

### SUMMARY OF THE INVENTION

An object of the present invention is to provide an ink jet recording head having a nozzle and an ink chamber formed in a silicon substrate, which can absorb the deviation between axes of a nozzle and an ink chamber, and to provide a fabrication method for fabricating the same ink jet recording head.

Another object of the present invention is to provide an ink jet recording head capable of performing a high quality printing.

The causes of the axis deviation of the nozzle and the ink chamber are an error in positioning the photo masks for forming etching patterns on the respective surfaces of the silicon substrate, a variation of thickness of the silicon substrate and a deviation of the silicon substrate from crystal faces, etc., and, therefore, it is impossible to eliminate the deviation itself. According to the present invention, a lateral gap is provided below an opening portion of a nozzle (a connecting portion between the nozzle and an ink chamber) and the axis deviation thereof, which occurs when the nozzle and the ink chamber are connected, is absorbed by the gap.

That is, the lateral gap is formed below the opening portion of the nozzle by opening the nozzle and then performing anisotropic etching through the opening portion of the nozzle. When anisotropic etchings are performed from the side of the nozzle opening and the side of the bottom of the ink chamber, the anisotropic etchings are connected in a position shifted to a center of the silicon substrate in thickness direction thereof. By the shift of the connecting portion to the center of the silicon substrate in the thickness direction thereof, the axis deviation in the vicinity of the nozzle opening portion is absorbed, so that the axis deviation of the ink chamber and the nozzle is compensated for. In this case, a cross point of extension lines of the pyramid shaped ink chamber and the lower plane of the nozzle opening portion is set in a position within the gap.

That is, the ink jet recording head according to the present invention, which includes at least one nozzle for jetting ink, at least one ink chamber connected to the ink nozzle and filled with ink, which is pressurized, and an ink supply path for supplying ink to the ink chamber, is featured by that at least the nozzle and the ink chamber are formed in one and the same crystalline substrate and a gap portion having a diameter larger than a diameter of the connecting portion of the nozzle and the ink chamber on the side of the ink chamber is formed.

In this case, the crystalline substrate is a crystalline silicon substrate, the nozzle is formed in a direction perpendicular to crystal face {100} of the silicon substrate, the ink chamber is defined by walls having surfaces in crystal faces {111} and extension lines of the wall surfaces in crystal faces {111} of the ink chamber cross each other in a position inside the gap portion.

Further, the nozzle is formed by dry etching a high density impurity diffusion layer formed by the silicon substrate doped with high density impurity and the ink chamber is formed by anisotropic etchings from the nozzle side and the side opposite thereto such that crystal faces {111} appear in the wall surfaces.

Further, the gap portion has a cross section, which is symmetrical about the nozzle, and is preferably 5 to 10 μm wide.

Further, a fabrication method of an ink jet recording head according to the present invention is featured by comprising the steps of forming a high density impurity diffusion layer in one surface of a silicon substrate, opening a nozzle by dry etching the high density impurity diffusion layer, forming an opening portion for etching in a position in the other surface of the silicon substrate, in which an ink chamber is to be formed, and forming the ink chamber by anisotropic etching from the both surfaces of the silicon substrate.

Further, a fabrication method of an ink jet recording head according to the present invention is featured by comprising the steps of forming a high density impurity diffusion layer in one surface of a silicon substrate, opening a nozzle by dry etching the high density impurity diffusion layer, forming an opening portion for etching in a position in the other surface of the silicon substrate, in which an ink chamber is to be formed, and forming the ink chamber by anisotropic etching from one of the surfaces of the silicon substrate and then by anisotropic etching from the other surface of the silicon substrate.

Incidentally, assuming that the nozzle side surface of the silicon substrate is an upper surface thereof, it is preferable that a gap portion having a cross section wider than a diameter of the nozzle is provided below the nozzle by anisotropic etching and a cross point of extension lines from four sides of a pyramid cavity of the ink chamber, which are defined by crystal faces {111} and the gap portion is positioned inside the gap portion.

### BRIEF DESCRIPTION OF THE DRAWINGS

Specific embodiments of the present invention will now be described, by way of example only, with reference to the accompanying of drawings in which:

FIG. 1 shows a structure of an ink chamber and a nozzle of an ink jet recording head according to the present invention;

FIG. 2a to FIG. 2g show fabrication steps of a fabrication method thereof according an embodiment of the present invention;

FIG. 3a to FIG. 3c show a progress of anisotropic etching of the ink chamber and the nozzle;

FIG. 4a to FIG. 4g show fabrication steps of a conventional fabrication method; and

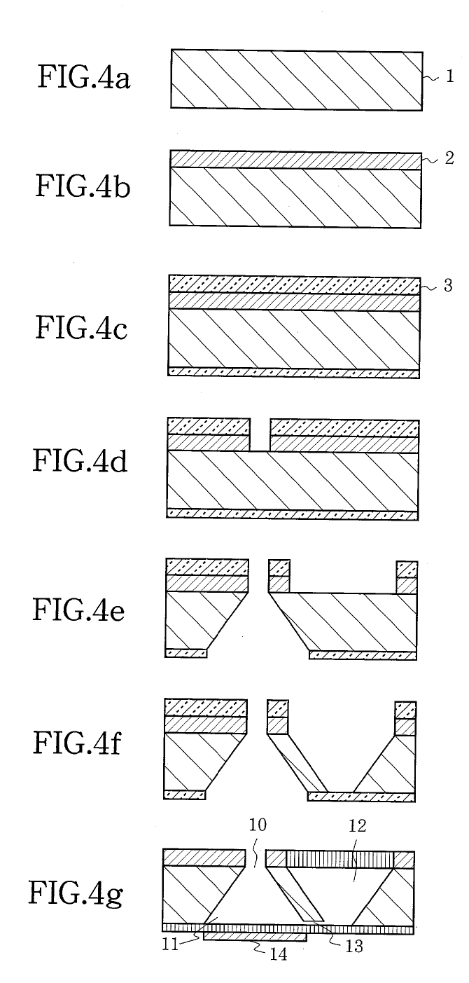

FIG. 5a and FIG. 5b illustrate an example of an axis deviation between the ink chamber and the nozzle.

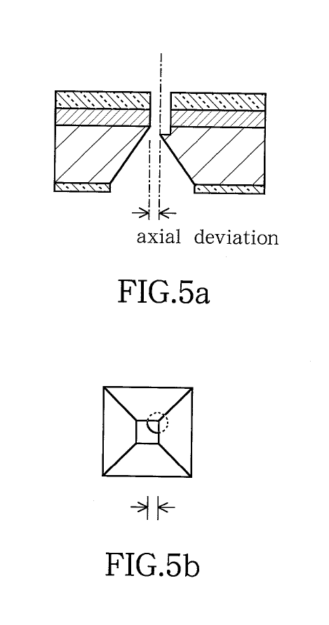

### DETAILED DESCRIPTION OF THE PREFERRED EMBODIMENTS

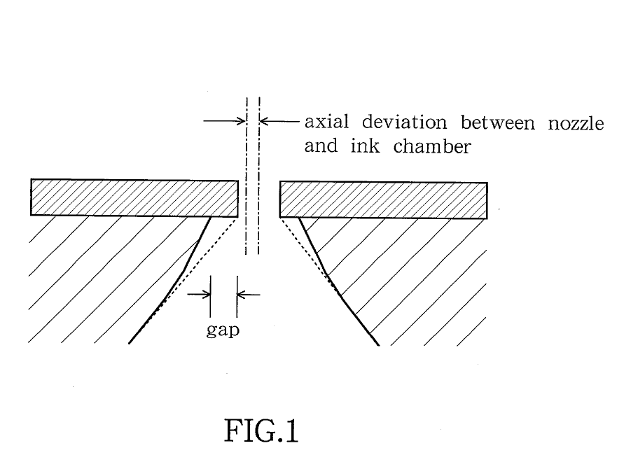

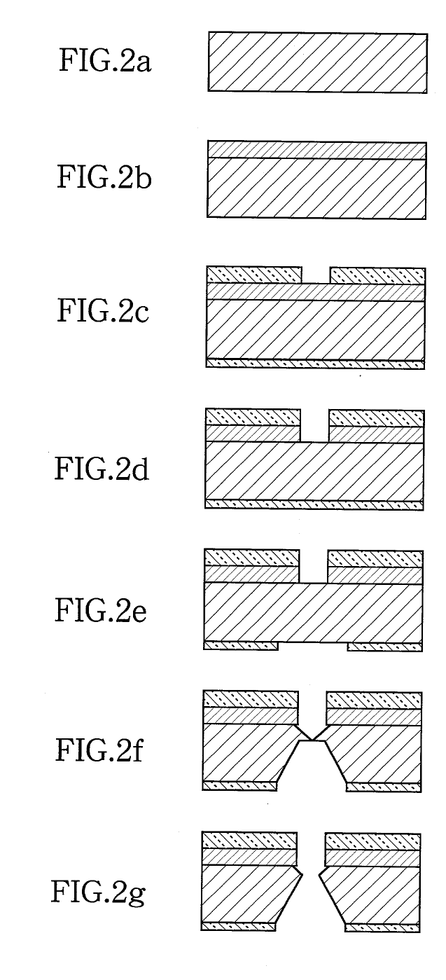

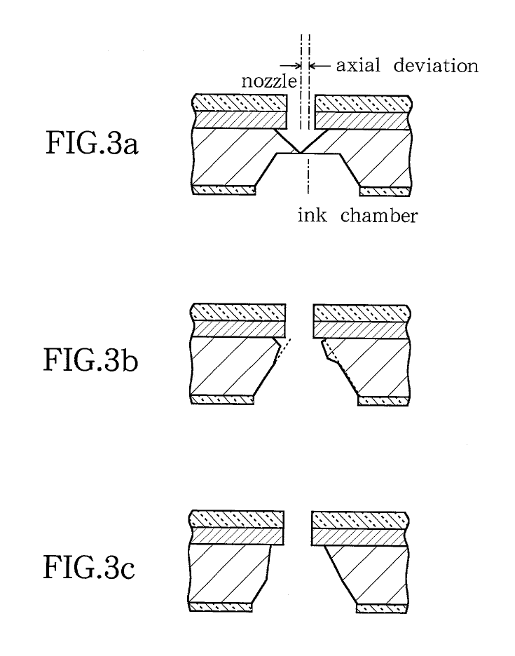

FIG. 1 shows a structure of an ink chamber and a nozzle of an ink jet recording head according to the present invention and FIG. 2a to FIG. 2g show fabrication steps of a fabrication method thereof according an embodiment of the present invention. Further, FIG. 3a to FIG. 3c show a formation of a gap in a connecting portion the nozzle and the ink chamber in an enlarged scale. Incidentally, an ink pool is not shown in these figures and description thereof is omitted.

As shown in FIG. 1, the present invention is featured by that the gap is provided below an opening portion of the nozzle and in a position at which a lower plane of the nozzle and the ink chamber are connected, that is, a cross point of the lower plane below the opening portion of the nozzle and extension lines of crystal faces {111} of the ink chamber. The gap is larger than an amount of deviation between an axis of the nozzle and an axis of the ink chamber. Assuming that a silicon substrate is 350 μm thick, a diameter of the nozzle is 20 to 40 μm and a side of a bottom of the ink chamber is 450 to 550 μm, the size of the gap is preferably 5 to 10 μm.

The depth of the nozzle depends upon the thickness of the high density boron diffusion layer and, in this case, is 8 to 12 μm. this is because, since the gap is formed below the nozzle opening, mechanical strength of the nozzle may become not enough if the depth is too small.

The fabrication steps for fabricating the ink jet recording head according to the present invention will be described with reference to FIG. 2a to FIG. 2g.

First, a high density boron diffusion layer 2 for forming a nozzle is formed by doping one of crystal faces {100} of a silicon wafer 1 with boron as in the conventional method (FIG. 2a and FIG. 2b). In this embodiment, the thickness of the high density boron diffusion layer 2 is about 8 μm. Thereafter, a silicon oxide layer 3 having thickness of 2 μm, which becomes an anti etching mask material, is formed by thermal oxidation. The silicon oxide layer is painted with photo resist material and a pattern for opening the nozzle is formed on a surface of the wafer (FIG. 2c). And then, the nozzle penetrating the high density boron diffusion layer 2 is formed by dry etching (FIG. 2d). Thereafter, a photo mask is provided on the other surface of the silicon wafer 1 in alignment to the one surface in which the nozzle is opened and a photo etching pattern is formed thereon to provide an opening portion of the ink chamber (FIG. 2e). And then, anisotropic etching is performed from the nozzle opening portion and the ink chamber opening portion simultaneously (FIG. 2f and FIG. 2g). The anisotropic etching is performed in ethylenediamine pyrocatechol water (EPW). Finally, the silicon oxide layer 3 is removed by using hydrofluoric acid solution and an ink supply path and a pressure generating mechanism, etc., are provided, resulting in an ink jet recording head.

FIG. 3a to FIG. 3c correspond to FIG. 2f and FIG. 2g, respectively, and show the formation of the gap in the connecting portion between the nozzle and the ink chamber according to a second embodiment of the present invention.

In the second embodiment, anisotropic etching is performed from the nozzle side and the bottom side of the ink chamber simultaneously. In this case, since the size of the nozzle is smaller than the ink chamber opening portion, a pyramid shaped cavity defined by four crystal faces {111} is formed in an initial stage of the etching and almost no etching progresses thereafter except side etching in crystal faces {111}. The anisotropic etching from the ink chamber opening portion progresses and a cavity on the nozzle side and the cavity on the ink chamber side are connected as shown in FIG. 3a. A position of the connecting portion is close to the nozzle opening in the thickness direction of the silicon wafer 1. The etching continues after the cavities are connected together to selectively etching protruded portions of the connecting portion, resulting in smooth surfaces (FIG. 3b and FIG. 3c). In this case, the etching is performed such that the cross point of the lower plane of the nozzle opening portion and extension lines of crystal faces {111} of the opening portion of the ink chamber is positioned inside the gap (or the step) formed below the nozzle opening portion.

By forming the nozzle and the ink chamber in this manner, the connecting portion of the etchings from opposite sides is shifted in the thickness direction of the silicon wafer 1 as shown in FIG. 3c and the axial deviation between the nozzle and the ink chamber, if any, is absorbed in the vicinity of the nozzle opening, so that it does not influence the ink jetting characteristics of the head. This is because, even if there is some axial deviation between the nozzle and the ink chamber, the anisotropic etching does not progress over the width of the gap on the nozzle opening portion side and the axial deviation can be absorbed by the gap, provided that the etching on the side of the ink chamber is within the gap width.

The larger the gap width (distance from the nozzle) can reduce the influence of the axial deviation. However, if the gap width is too large, the mechanical strength of the nozzle is lowered and void tends to stay during ink is jetted. Therefore, the gap width is preferably 5 to 10 μm. When the axial deviation is larger than the width of the gap formed in the opening portion of the nozzle, etching depending upon the etching on the side ink chamber is performed and etching below the nozzle opening portion progresses inside the silicon wafer 1, so that there is a case in which the axial deviation can not be absorbed.

Incidentally, the anisotropic etching in the embodiment shown in FIG. 2a to FIG. 2g is performed from the nozzle opening portion and the ink chamber opening portion simultaneously. However, it is possible to provide the same structure by performing the anisotropic etching from the nozzle opening portion first to form a pyramid shaped cavity as shown in FIG. 3a and then forming the ink chamber opening portion and performing the anisotropic etching therefrom, since the progress of etching is the same as in the case shown in FIG. 2a to FIG. 2g.

As described hereinbefore, in the present invention, even when the nozzle and the ink chamber of the ink jet recording head are deviated in position from each other, the deviation can be absorbed. Therefore, the positional deviation, if any, does not influence on the ink jetting function and the ink flying function, so that it is possible to realize high quality printing.

What is claimed is:

1. An ink jet recording head comprising: at least one nozzle for jetting ink; at least one ink chamber connected to said ink nozzle and filled with ink, which is pressurized; and an ink supply path for supplying ink to said ink chamber,
wherein at least said nozzle and said ink chamber are formed in one and the same crystalline substrate; and
a gap portion having a diameter larger than a diameter of a connecting portion of said nozzle and said ink chamber on the side of said ink chamber is formed.

2. An ink jet recording head as claimed in claim 1, wherein said crystalline substrate is a crystalline silicon substrate;
said nozzle is formed in a direction perpendicular to crystal face {100} of said silicon substrate; and
said ink chamber is defined by walls having surfaces in crystal faces {111} and extension lines of said wall surfaces in crystal faces {111} of said ink chamber cross each other in a position inside said gap portion.

3. An ink jet recording head as claimed in claim 2, wherein said nozzle is formed by dry etching a high density impurity diffusion layer formed by said silicon substrate doped with high density impurity; and
said ink chamber is formed by anisotropic etchings from the side of said nozzle of said silicon substrate and the side opposite thereto such that crystal faces {111} appear in said wall surfaces.

4. An ink jet recording head as claimed in any of claims 1 to 3, wherein said gap portion has a cross section, which is symmetrical about said nozzle, and is 5 to 10 μm wide.

5. A method for fabricating an ink jet recording head, comprising the steps of:
forming a high density impurity diffusion layer in one surface of a silicon substrate;
opening a nozzle by dry etching said high density impurity diffusion layer;
forming an opening portion for etching in a position in the other surface of said silicon substrate, in which an ink chamber is to be formed; and
forming said ink chamber by anisotropic etching from the both surfaces of said silicon substrate.

6. A method for fabricating an ink jet recording head, comprising the steps of:
forming a high density impurity diffusion layer in one surface of a silicon substrate;
opening a nozzle by dry etching said high density impurity diffusion layer;
forming an opening portion for etching in a position in the other surface of said silicon substrate, in which an ink chamber is to be formed; and
forming said ink chamber by anisotropic etching from one of the surfaces of said silicon substrate and then by anisotropic etching from the other surface of said silicon substrate.

7. A method for fabricating an ink jet recording head, as claimed in claim 5 or 6, wherein said nozzle side surface of said silicon substrate is an upper surface thereof, a gap portion having a cross section wider than a diameter of said nozzle is provided below said nozzle by anisotropic etching and a cross point of extension lines from four sides of a pyramid cavity of said ink chamber, which are defined by crystal faces {111} and said gap portion is positioned inside said gap portion.
